(19) United States
(12) Patent Application Publication
(10) Pub. No.: US 2020/0372497 A1
(43) Pub. Date: Nov. 26, 2020

(54) PHYSICAL CURRENCY FOR ENABLING IN-PERSON COMMERCIAL TRANSACTIONS USING BLOCKCHAIN TECHNOLOGY

(71) Applicant: Franz Stradal, Aachen (DE)

(72) Inventor: Franz Stradal, Aachen (DE)

(21) Appl. No.: 16/420,171

(22) Filed: May 23, 2019

(51) Int. Cl. G06Q 20/36; G06Q 20/06; G06Q 20/32

(52) U.S. Cl. CPC G06Q 20/3678; G06Q 20/3278; G06Q 20/065

(57) ABSTRACT

The present disclosure relates generally to a system of wallets and micro-wallets used to store and transfer cryptocurrencies. The physical CashCryps module and its software allows payors and payees to transfer cryptocurrency during purchasing transactions using physical devices. The limitations of virtual wallets are overcome by this invention. This invention provides simple and secure access in a physical embodiment, thus eliminating the need for complicated transfers involving private keys, public keys, internet-dependent transactions, gas, and other limitations of cryptocurrency wallet systems that are known in the art.

### CROSS-REFERENCE TO RELATED APPLICATIONS

This application claims priority under 35 U.S.C. § 119 (e) to U.S. Provisional Patent Application Ser. No. 62/674,972 filed on May 22, 2018, which is a continuation of U.S. Patent Application Ser. 62/683,147 filed on Jun. 11, 2018, the entire contents of which are hereby incorporated by reference.

### FIELD OF THE DISCLOSURE

The present disclosure relates generally to a system of wallets and micro-wallets used to store and transfer cryptocurrencies. More specifically, the present disclosure is a cryptocurrency micro wallet device, system, and method which overcomes problems faced by consumers of cryptocurrencies. This invention simplifies existing methodologies and provides enhanced security for offline-to-offline cryptocurrencies transactions and the blockchain. Due to known limitations in the blockchain protocol, specifically the strict numeration, previous cryptocurrency wallets are not functional when offline due to the high risk of getting out of sync.

### BACKGROUND

A cryptocurrency wallet is a device a physical medium, program or a service which stores the public and/or private keys and can be used to track ownership, receive or spend cryptocurrencies. The cryptocurrency itself is not in the wallet. In case of bitcoin and cryptocurrencies derived from it, the cryptocurrency is centrally stored and maintained in a publicly available ledger called the blockchain.

The blockchain is a public ledger that records cryptocurrency transactions and is implemented as a chain of blocks, each block containing a hash of the previous block up to the genesis block of the chain. A network of communicating nodes running software maintain the blockchain and transactions using readily available software applications. Network nodes can validate and add transactions to their copy of the ledger, and then broadcast these ledger additions to other nodes. To achieve independent verification of the chain of ownership each network node stores its own copy of the blockchain. When a new block of accepted transactions is created, it is added to the blockchain and quickly published to all nodes. The software determines when a cryptocurrency is exchanged to prevent double-spending.

A wallet stores the information necessary to transact and store cryptocurrency digital credentials for access and transfer through the blockchain. A wallet is a collection of cryptocurrency public-key cryptography, in which two cryptographic keys, one public and one private, are generated.

Wallets can operate in multiple nodes with inverse relationships with regards to reliability and computational requirements. Transactions are verified by downloading a copy of the mined blocks making up the blockchain, preventing transactions on the blockchain that break or alter the network rules. Due to the size and complexity of the blockchain, the blockchain cannot be downloaded and verified in its entirely by any single device. By downloading only part of the blockchain a wallet can use less power and lower bandwidth.

Wallets may store credentials to access funds in a virtual wallet accessible through the cloud. As a result, the user must have complete trust in the online wallet provider.

As an alternative to virtual wallets, physical wallets store the credentials necessary to spend cryptocurrency offline by carrying a private key. Physical wallets have taken various forms including metal tokens with the private keys that are accessible under a security hologram. The security hologram self-destructs when removed from the token, showing that the private key has been accessed. Originally, these tokens were struck in brass, but later used precious metals, like gold, as cryptocurrency prices increased. These hardware wallets keep credentials offline while facilitating transactions.

A wallet, comparable to a bank account, contains a pair of public and private cryptographic keys. A public key allows other wallets to make payments to the wallet's address, whereas a private key enables the spending of cryptocurrency from that address. Wallets can either be digital applications called “apps”, or stored in hardware contained on a physical device. The private key is either stored with the user or remotely and transactions are authorized by a third party. Multisignature wallets require multiple parties to sign a transaction for any digital money can be spent.

### BRIEF SUMMARY OF THE INVENTION

The present invention is also a significant improvement over past and other currently available virtual cryptocurrency wallets in the way cryptocurrency is securely stored and transferred between parties. The physical CashCryps module and its software allows payors and payees to transfer cryptocurrency during purchasing transactions using physical devices. The limitations of virtual wallets are overcome by this invention.

The solutions embodied in this invention are easy to understand, simple to use, available everywhere, and secure. The problems known to be caused by different vectors is overcome by this invention, whereby, this invention is not an online only wallet that exists only when connected to the internet. This invention provides simple and secure access in a physical embodiment, thus eliminating the need for complicated transfers involving private keys, public keys, internet-dependent transactions, gas, and other limitations of cryptocurrency wallet systems that are known in the art.

This invention is characterized by micro-wallets generated from owner wallets, in the size of typical fiat, for example $1, $2, $5, $10, $20, $50, $100, and so forth. This invention handles cryptocurrencies like coins, and other fiat, as if you were paying in cash.

This invention is characterized by typical offline-to-offline transactions that sends any number of micro-wallets on this invention, the CashCryps device, to another CashCryps device, or to a PT. If the payor does not have the right amount of cryptocurrency on the payor's CashCryps device to pay the payee, or merchant, the payee can provide change. As this invention is characterized by its own firmware that cannot be changed, this invention provides a secure wallet, that when moved, is deleted, such as when moved to the merchant.

To make the micro-wallets secure with respect to the coin value stored on the micro-wallets, this invention is comprised of a secure server-side and signature feature. The wallet owner requesting the cryptocurrency receives a list of micro-wallets. The micro-wallets are created and then filled with cryptocurrency from the owner's wallet.

For each coin size there is a private key on the CashCryps device, or the PT, that is easy to use offline to verify that the desired value has been transferred. Since only the server has the private key for the amount and signature and the public has the public key for reading, only the server can create new coins that are secure while recording the transaction.

The micro-wallets can be endless circulated like coins, but only solved to other wallets and exchanged online, due to the blockchain protocol. The micro-wallets are 100% compliant and safe to physically transfer, as it is a private key to a wallet with a specific amount. One the device connects online the device can approve the transaction by checking with the server or solving the blockchain.

By generating multiple micro-wallets from an original wallet and paying with them, the merchant can solve them instead of giving them to the next person; therefore, it is safe to circulate the micro-wallets.

The problem with micro-wallets that are currently known in the art is the micro-wallet is copied rather than moved. This invention solves this problem such that CashCryps marks the micro-wallet before sending as deleted. If the transfer is approved, CashCryps deletes the micro-wallet. If the transactions are not finalized, the micro-wallet stays marked as deleted until the CashCryps goes online and destroys the micro-wallet and creates a new one.

This invention also prevents the amount of the micro-wallet from unauthorized changes once the micro-wallet is signed from the server-side private key by checking and marking the coins before payment allowing the merchant to check the micro-wallet coins after the transfer, or solve. These risks are mitigated with the GSM version of CashCryps where checking micro-wallets does not create a traceable lead and the transfer is still offline-to-offline.

Coinbase works on trading places where the broker has the private keys in his protected database. The payee controls the sale and purchase orders with his login name, password, and through two-way verification, but the payee does not control the wallet. To do so, the payee must transfer the coin token to the payee's own wallet.

Activity Cryps are CRYPS in a master wallet that the payee owns but does not have in the payee's wallet. By making a payment, the payee may receive Activity Cryps, CRYPS, or Cash, but the payee does not need to have extra Ethereum in the payee's wallet. Activity Cryps are a representation of CRYPS, covered 1:1 by CRYPS in the CashCryps master activity Cryps wallet. As it is a database entry transaction, the transaction is instant and secure. Activity Cryps to Activity Cryps are no-time-no-fee transactions, and do not require additional Ethereum. Activity Cryps to CRYPS transactions involve a small fee from the companies to perform the transfer where the same amount is taken from the Activity Cryps as the fee and signed to the company reserve. Activity Cryps to cash transactions are sold through a trading place or bought back to the company and is instant and buffered by company cash with a fee that is discounted and paid in cash. CRYPS, or other cryptocurrencies, to Activity Cryps have the benefit for the payee after the conversion to Activity Cryps in that the transactions on the marketplace and the games are instant without any fees.

In once embodiment, this invention can perform a CRYPS to Ethereum payment without forcing the payee to have Ethereum by using its own network for CRYPS only and synchronizing with the Ethereum network; or in another embodiment, by being its own blockchain, independent from Ethereum, this invention builds trust of the miners and customer's while gaining acceptance on exchange markets; or in yet another embodiment, as a broker, by containing all the wallets and private keys through Activity Cryps where the transferee the needs Ethereum on the wallet and do the transaction with an extra fee which works only if the wallet the Cryps originate contain enough value. Since there is no official way to let an independent third person pay for a transaction, the transaction is embedded in soft contract and distributed over the blockchain where the receiver cannot directly pay for the transaction, but can send a little gas to the sender and get a fee after effectively three transactions are made.

### BRIEF DESCRIPTION OF DRAWINGS

FIG. 1. is a front view of an exemplary CashCryps wallet device of the present disclosure.

FIG. 2. is a front view of a prototype of the CashCryps wallet device of the present disclosure.

FIG. 3. is an exploded view of the hardware components of the CashCryps wallet device of the present disclosure.

FIG. 4. is a schematic of components of the CashCryps wallet device of the present disclosure.

FIG. 5. is a schematic of components of the CashCryps wallet device of the present disclosure

FIG. 6. is a schematic of components of the CashCryps wallet device of the present disclosure

FIG. 7. is a flow chart showing transmission of package in CashCryps wallet device system of the present disclosure.

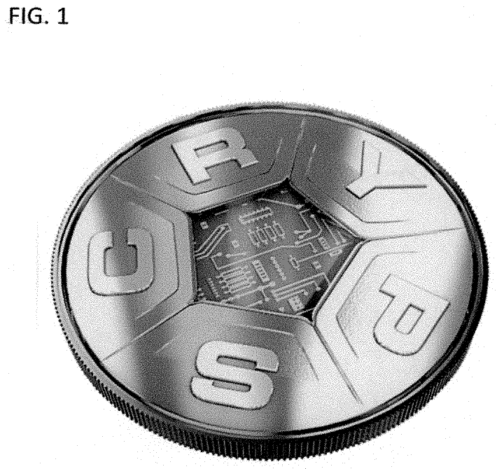

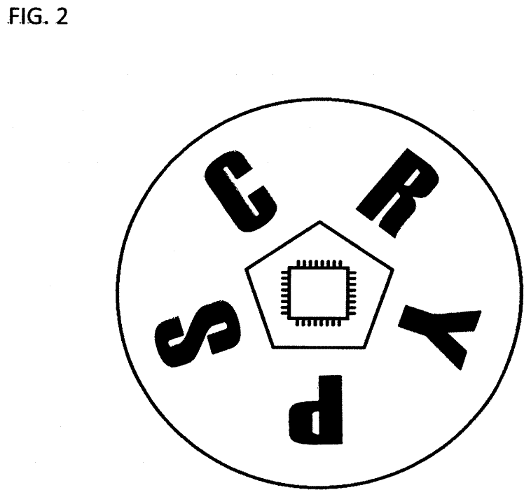

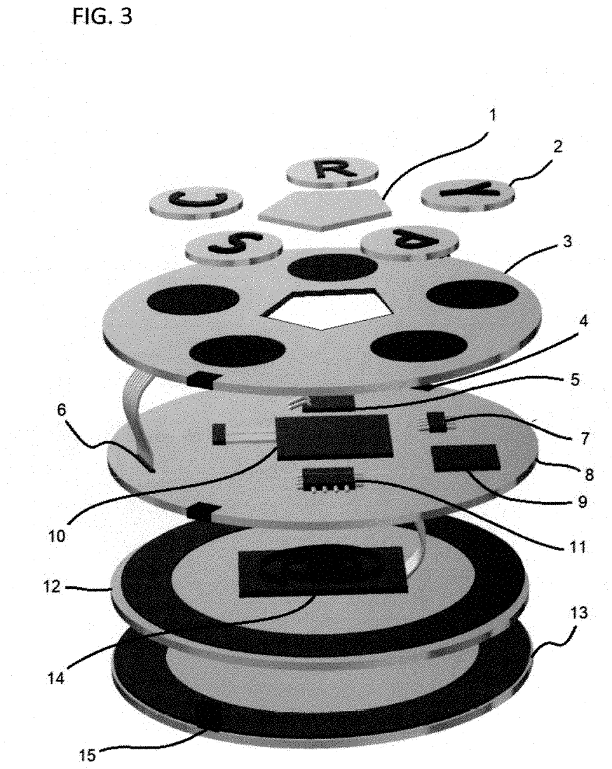

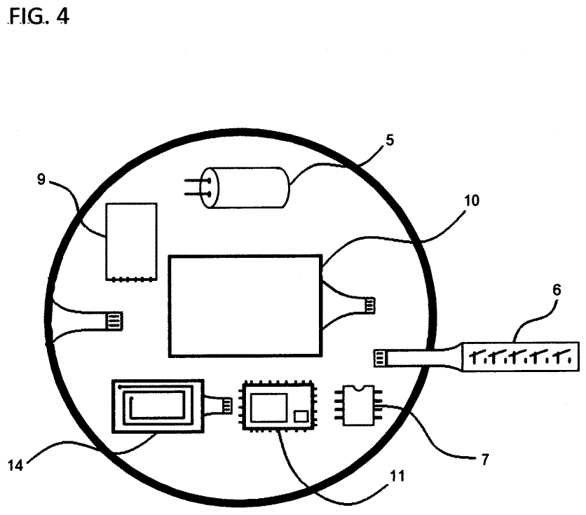

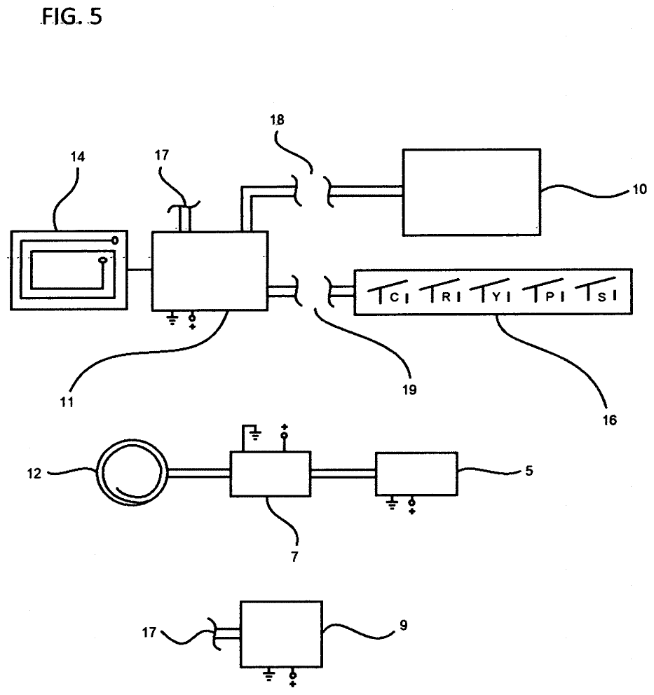

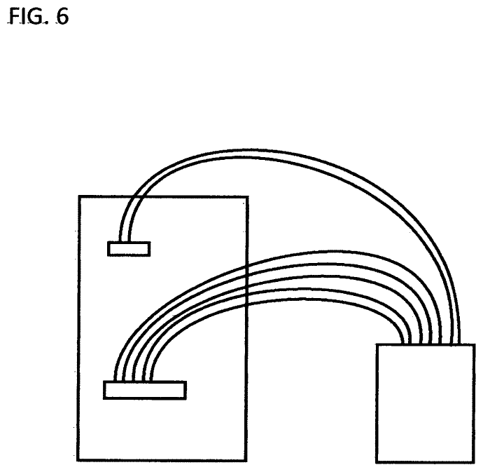

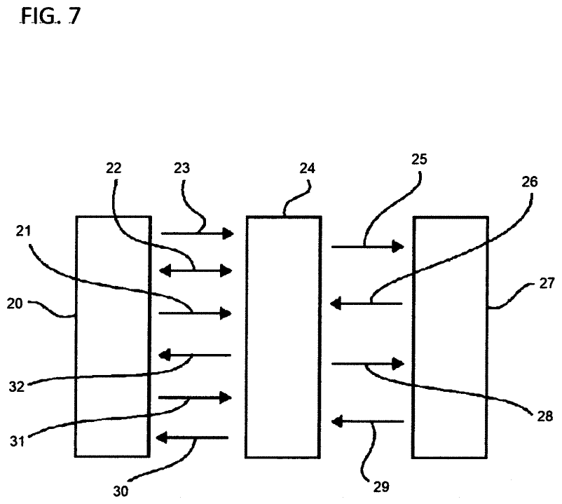

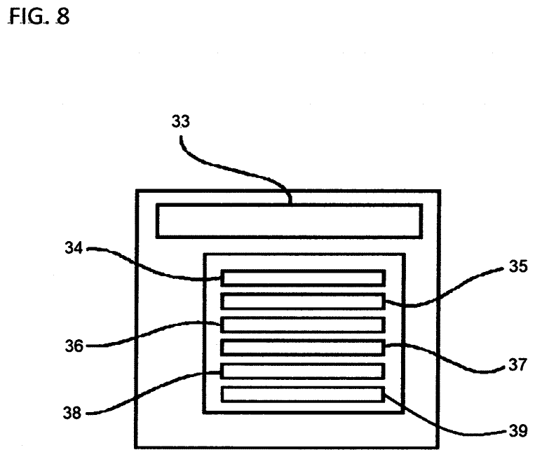

### DETAILED DESCRIPTION OF THE INVENTION

This invention is comprised of a round device, but may be rectangular or square, with a height of no more than 7.5 mm. This invention may have a height of 3 mm or less with FCC certification wherein this invention utilizes exclusive eInk, BL652 packing, thin film flex PCB, and does not require chip design. In one embodiment, this invention is comprised of a display that shows the cryptocurrency balance and five keys. In one embodiment, this invention transfers currency by holding this invention in close proximity to the merchant's smartphone or pay-terminal, which may be a specific smartphone or pay-terminal. In one embodiment, the payment amount appears on the display of this invention. When the merchant presses “ok” on the display of this invention the cryptocurrency is transferred and this invention contains with the exact amount of cryptocurrency to be transferred to the payee or merchant.

In one embodiment, the hardware of this invention is future proof and capable of talking to contact free pay terminals for credit cards. In one embodiment, the device can store credit card credentials and be used to pay on regular pay terminals as credit card with approval from credit card company and pay company required.

The method of this invention has several steps. In one embodiment, the first step is to give the cryptocurrencies a physical representation that can be used independently of a smartphone or computer, like cash or a credit card. In one embodiment, for cash like behavior, the payee must be able to give the merchant this invention. The advantage of this invention is the low cost of device relative to the amount of cryptocurrency to be paid, and in one embodiment, this IS version is unprotected. In one embodiment, for credit card like behavior, the payee must acknowledge the transaction with a physical interaction with this invention, such as pressing the Y button, and the payor sees the new balance on the display of this invention. In one embodiment, as light security, this invention allows the payee to have a pin-code on this invention, a combination of the five buttons. In one embodiment, for additional security, the payee may be able to KYC and connect this invention with a wallet. In one embodiment, to protect against misuse and loss, and for extra security, the payee may add a two-way authentication with its own smartphone or computer.

In one embodiment, this invention may increase speed and reduces gas into two steps. The first step is this invention is comprised of a master wallet on a server and transfers only ownership in the DB. In a second step, this invention has KYC, a prediction, and this invention grants the transaction like credit cards. In one embodiment, this invention allows crypto-to-crypto and crypto-to-fiat conversion on the backend of this invention so that merchants can receive money instead of BTC or CRPY. In one embodiment, to facilitate the instantaneous transfer of cryptocurrency, this invention uses the same prediction model. In one embodiment, for ERC20 transactions, this invention pushes a small amount of ETH to the wallet to pay the gas that is compensated with an individual fee which may be currency, whether or not the payee has the ETH.

In one embodiment, there are versions of transactions. In one embodiment, this invention will have the currency in the master wallet of this invention and will transfer ownership. In the same embodiment, the wallet of this invention is online and private to the payee. In the same embodiment, the wallet of this invention has a private key that is on this invention only. In one embodiment, the payee requests a conversion during the transfer. In one embodiment, the offline payments of this invention will allow two options. In one embodiment, the payor hands this invention over as an unprotected device to the payee. In one embodiment, the Second option for the payee is to pre-create transactions in micro wallets. In one embodiment, the transaction transfers the micro-wallet to another device or computer. In one embodiment, this invention is totally independent, wherein, this invention is ready to take a GSM/WIFI chip in the compound. In one embodiment, transactions can be made totally independent at a later time.

In one embodiment, this invention is comprised of software and firmware. The firmware controls all functions of this invention, including this invention negotiates over NFC a secure protocol to connect for the transferee with Bluetooth. In one embodiment, this invention has five (5) keys. In one invention, this invention has more than five (5) keys. In one invention, this invention shows on the display the balance, battery status, connectivity, request to send cryptocurrencies or fiat, and asks for action of the payee. In one embodiment, this invention controls the status of security with pin or two-way authentication. In one embodiment, this invention signs transactions as its stores the private key on this invention only.

In one embodiment, this invention has a wallet key that is a hardware wallet, with or without a communication key to start transactions on the server. In one embodiment, this invention stores the control of the history of transactions and actions. In one embodiment, this invention allows the configuration of this invention. In one embodiment, this invention allows an authenticated payee to change status. In one embodiment, this invention creates offline transactions by pre-created TAN or micro wallets. A micro wallet is a regular wallet that transfers cryptocurrency as a private key. The advantage of a micro wallet is the cryptocurrency is instantly transferred. The micro wallet can be controlled by its holder, but with the disadvantage that the amount cannot be changed for offline transfers.

In one embodiment, this invention this invention has a server that creates, manages, and supports the payee, which can be a general-purpose CRM/CMS. In one embodiment, this invention records and logs all actions and transactions. In one embodiment, this invention predicts reliability of transactions and pre-approves KYCed customers. In one embodiment, this invention has an exchange function comprised of a three-way transaction that avoids banking regulations. In one embodiment, instead of facilitating a transaction from the payee wallet to the merchant wallet, the server of this invention buys currency from the payee. For example, the payor gives the payee the purchased item and the payee sells the item using the server of this invention to reward the payee in what is termed the “airline miles system”. The purchased items are purchased from the payee and sold for miles to the payee as in inventive under the loyalty program with no bank or tax implications.

In one embodiment, this invention has an application that requests to receive cryptocurrency in what is termed the “merchant mode”. In one embodiment, this invention this invention sends currency in what is termed the “payee mode”. In one embodiment, this invention is configured to set up a private key. In one embodiment, this invention changes security level. In one embodiment, this invention calculates exchange rates and fees. In one embodiment, this invention requests a transfer including exchange.

In one embodiment, this invention is manufactured in stages. In one embodiment, this invention is comprised of a prototype. In one embodiment, the payment process of this invention is acknowledged and registered from the backend, but is initiated from this invention over the payee application. This invention is comprised of the final hardware, the embedded chipset BL652 on a development board, NFC, Bluetooth, eInk display and a first version of the firmware. In one embodiment, this invention has a wireless GSM/WIFI component in addition to Bluetooth and NFC. In one embodiment, this invention connects to the internet over the payee application for automatic updates that is secure even if the traffic is recorded and decrypted as the private key never leaves the device (Transaction Version 1) or the server (Transaction Version 2 and 3).

In one embodiment, this invention is comprised of a hardware wallet. In one embodiment, this invention creates a final PCB with all components and stores the private key in the protected flash memory of the embedded chip. In one embodiment, this invention signs a transaction on the chip. In one embodiment, this invention is comprised of a case with final dimension and haptics. In one embodiment, this invention is 20% smaller than the actual case. In one embodiment, this invention is comprised of an application (Merchant Case) that requests money or CRYPS/ETH from another embodiment of this invention (Payee case). In one embodiment, this invention sends money or CRYPS/ETH from a device to a receiver. In one embodiment, this invention is comprised of an exchange rate from finance life. In one embodiment, this invention initiates a wallet to wallet transfer. In one embodiment, this invention, this invention automatically updates itself over the application. In one embodiment, this invention is comprised of a server. In one embodiment, this invention is comprised of a payee account. In one embodiment, this invention sends a signed package to the Ethereum network. In one embodiment, this invention registers all balances. In one embodiment, this invention update updates upon request. In one embodiment, this invention the server buffers.

In one embodiment, this invention instantly transfers for master wallet payee. In one embodiment, this invention acknowledges instant transfers for KYC customers. In one embodiment, this invention is comprised of other services that integrate including XSOLLA and Microsoft Pay. In one embodiment, this invention asks for anything running on Bluetooth devices. In one embodiment, this invention prepares credit card like payments. In one embodiment, this invention stores credit card credentials. In one embodiment, this invention run credit card credentials for approval. In one embodiment, this invention is sized down by redesigning the PCB cut outs for BL652 and LiPo and connectors. In one embodiment, this invention is comprised of a redesigned case.

In one embodiment, this invention prepares to pay services through conversion to credit card credentials. In one embodiment, this invention converts from crypto deposit to prepaid credit card on device instead of having the credit card independent on this invention feeding from the cryptocurrency wallet as deposits. In one embodiment, this invention operates offline-offline using pre-created TANs or pre-created micro wallets. In one embodiment, this invention mechanically harvests instead of QI and LiPo battery. In one embodiment, this invention has a mechanical element to harvest energy by shacking this invention. In one embodiment, the mechanics of this invention is similar to automatic watches. In one embodiment, this invention is comprised of a rotating light, here turning a little dynamo and not a hook like in watches. In one embodiment, this invention is comprised of GSM. In one embodiment, this invention has a GSM module inside that creates not just more security and an option to pay and update without the payee having a smartphone with installed application; it also unlocks new markets like Africa.

In a preferred embodiment, this invention pays direct from device to device if one of this invention has a GSM module which creates a whole new ecosystem of payments. In one embodiment, this invention is sized down from a total amount of 50,000 sold devices the size of this invention is lower than three inches in width and three millimeters in height. In one embodiment, this invention requires different packing of the embedded chip and direct mount to a flex PCB. In one embodiment, this invention, the LiPo battery and eInk component come as special configurations. In one embodiment, this invention this invention can roll out a credit card sized device. In one embodiment, this invention is comprised of a passive version (NFC harvesting). In one embodiment, this invention is free from active energy components. In one embodiment, this invention LiPo and QI are removed and this invention runs only on the energy harvested from the NFC loop. In one embodiment, this invention requires the next generation embedded chip that works only if held up to an NFC device.

In one embodiment, this invention is comprised of four levels of technology. In one embodiment, this invention is comprised of a standard embedded microprocessor, NFC, BT, QI, LiPo battery, and buttons. In one embodiment, this invention is comprised of a GSM/GPRS embedded microprocessor, NFC, BT, QI, LiPo battery, buttons, and a GSM modem. In one embodiment, this invention is comprised of custom components that unpack the embedded CPU module from the metal cap and its own PCB and creates a specific eInk. In one embodiment, this invention is comprised of custom packing for the LiPo battery. In one embodiment, this invention is comprised of a passive embedded microprocessor, NFC, buttons. The passive device works only with the energy harvested from the NFC master, like phone, pay terminal or other device with battery. In one embodiment, this invention is built based on the BL652 from Laird. In one embodiment, this invention runs an Arm Cortex M4 and is coded in C. In one embodiment, this invention, changing to another chip does not affect the code or the function but enable (even) energy consumption and smaller form factors. In one embodiment, this invention is comprised of standard forms. In one embodiment, this invention is comprised of market available components build into this invention that can be four to five millimeters on the thickest and below one millimeter in the thinnest part. In one embodiment, this invention in standard form is round and below seven centimeters in diameter and approximately fifty-six millimeters thick. In one embodiment, this invention is thin with factory modified components (not using the metal cap and the PCB of the BL652, and a specifically produced eInk). In one embodiment, this invention reaches a maximum height of three millimeters and can reduce the diameter to at least five centimeters. In one embodiment, this invention all components are mounted direct on a flex PCB without additional packing. In one embodiment, this invention requires new certificates from the FCC.

In one embodiment, this invention is comprised of a credit card format with the hardware from the thin version in a comfortable formed credit card device. In one embodiment, this invention is a round coin version. In one embodiment, this invention is comprised of a payment flow of CashCryps. In one embodiment, this invention has a security component. In one embodiment, this invention is comprised of a private key that is needed to sign a payment that never leaves this invention so even an unsecure recorded connection does not expose any secrets or allow stealing. In one embodiment, this invention acknowledges any interaction, especially payments, with this invention more secure an interaction with this invention is needed in comparison to a credit card that does not have an active system. In one embodiment, this invention receives a pin code in the terminal, and in one embodiment this invention does not receive a pin code in the terminal.

In one embodiment, this invention is comprised of a “y” key only that initiates the transaction when the payer presses the “Y” button on this invention. In one embodiment, this invention is comprised of a local pin code that the payer types in with the 5 keys this invention. In one embodiment, this invention has a two-way authentication that the payer types in his phone a pin code and receives a SMS. In one embodiment, this invention this invention is comprised of a PT Merchants pay terminal that can be a pay terminal or a phone with the application of this invention installed. In case of credit card payment, this invention is comprised of a regular pay terminal for contactless payments. In one embodiment, this invention is comprised of BT Bluetooth. In one embodiment, this invention is comprised of NFC that is Near Field Communication for a Pay flow that is offline to online. In one embodiment, this invention, the merchant requests in the application of this invention from his phone or a pay terminal, PT from here on, and the amount the payor must pay. In one embodiment, this invention the merchant is not required to know the customer as the CashCryps identifies itself. In one embodiment, the merchant requests in the currency that the merchant accepts. Conversions in the currency this invention has and payout on the requested currency is made on the server of this invention.

In one embodiment, the merchant selects “Request Payment” and enters the amount in a currency selected by the merchant. In one embodiment, the merchant may ask the payor to enter the amount and type of currency. In one embodiment, the merchant enters a reference number for the payment to be tax compliant or just to connect the payment to a specified accounting system that is automated from the application for convenience by connecting the payment to the cash system from the merchant via API. In one embodiment, the customer holds this invention to the phone or pay terminal. In one embodiment, the PT is an NFC master device and wakes up the electronics in the CashCryps. In the first embodiment of this invention the battery is charged by the QI first. In one embodiment, the charge lasts for one hundred transactions. In other embodiments, the CashCryps works with the energy harvested from NFC only. In one embodiment, this invention gives the requesting phone or device the key for a secure connection (HTTPS concept) over the NFC.

In one embodiment, this invention and the phone or terminal establish on a Bluetooth connection (BT connect via NFC) and is known in the art for all modern Bluetooth devices like headphones. In one embodiment, the CashCryps sends the merchant the public ID of his wallet and what currencies it holds without the amount, ideally just one. In one embodiment, this invention connects via Bluetooth with the CashCryps application and sends the ID and currencies available to the PT through a packet already secured by the connection. In one embodiment, the merchant needs to know the public ID, and another the merchant does not need to know the public ID. In one embodiment, public ID comes in a signed package. In one embodiment, this invention sends the public ID for security reasons and to prevent fraud.

In one embodiment, the PT checks the public ID over our server for fraud alert while the transactions are ongoing. In one embodiment, the PT sends the requested amount that is converted in the available currencies through an automated process where the PT protocol negotiation between this invention and CashCryps and PT and exchanges the Payee ID and currencies and sends requests that do not require manual action. In one embodiment, when the request is sent to CashCryps, the PT compares the requested currency with the available currency, or currencies; and if the currencies are different, the PT sends a request to the backend to translate, following the actual exchange and risk fee to cover quick exchange rate jumps, in the available currencies. Our backend updates the exchange rate in real-time with the bigger exchanges, such as Binance.

In one embodiment, the converted request or original request, if available on the CashCryps, is sent over BT to the CashCryps. In one embodiment, this invention checks if it can transfer the amount, and if not, the transaction ends. In one embodiment, the CashCryps CPU sums up, if needed, the currencies it has and offers it to the owner on the display. The offered transaction can involve one or more currencies. In one embodiment, this invention shows on the display the request in the available currency and if the merchant has requested a different currency, the requested currency. At this time, nothing is sent to the PT and on the display the CashCryps shows the request. If the CashCryps does not have the needed balance the transfer ends showing on the CashCryps and the PT “Rejected”.

In one embodiment, if the payee agrees the payee presses the “Y” button, and if not, the payee presses the “C” button and the transaction ends here. If the payee accepts, this invention creates a package that is comprised of the sender ID, receiver ID, amount, number, gas and noon, signs it with the private key, and gives the package to the merchant. If the payee presses the “y” button the request is processed. In one embodiment, if CashCryps is protected with a pin code the payee must enter the pine code. In one embodiment, if CashCryps is a two-way authentication, the payee must enter a code on his smartphone.

In one embodiment, the CPU creates the package and signs it with the private key. The private key is stored on the chip in the secure flash memory. It cannot get read out other than from the firmware. It is hardware encrypted and the firmware cannot get changed externally. The firmware is implemented during assembly. In one embodiment, a pin code is required to initiate the transaction and the private key is additionally encrypted with the pin code and is decrypted the moment the payee types in the payee pin code. In one embodiment, the package is signed twice: first with the private key and a second time with a firmware key. Only the CashCryps server can unpack the outer signature to make the package ready for the blockchain network. In one embodiment, this invention sends the PT the signed package direct to the blockchain network, to ensure the security of the CashCryps payee. In one embodiment, the signed package is sent to the PT via BT. In one embodiment, the PT sends the package to the backend of this invention.

In one embodiment, if the transaction is done with the server, the merchant receives an update package from the server for this invention. The update package is encrypted and can only decrypted with the private keys so there is a key on the server of this invention that behaves like a private key to the private key in this invention. In one embodiment, the private key of this invention behaves like a public key to the private key on the server. In one embodiment, the server unwraps the outer signature and registers the transaction request. In one embodiment, if it is a strict wallet to wallet transaction the server sends the package to the blockchain network and informs the PT to accept and approve status. In one embodiment, this invention is connected with a master wallet on the server and the server can instantly approve the request. In one embodiment, after the approval, the server can start the conversion in another currency if requested, and if approved, both participants are KYC and the payout is predicted as approved and sent directly to the PT wallet, PayPal, credit card, or account.

In one embodiment, the merchant through the application or the terminal, sends the signed package to the backend of this invention or the blockchain network. This is a very important element as using the backend of this invention has two benefits. First, this invention facilitates instant conversion in other currencies, including fiat, and the approval of customers with KYC. If a merchant wants to use the service for security and speed, the benefit of sending the package directly to the blockchain network is increased anonymity, but requires the merchant to have a wallet, understand the market, and change the settings of the application.

In one embodiment, after sending the package to the merchant, this invention ticks the number one up, as the blockchain network will do while processing the transaction. It also recalculates the balance and updates the display so the customer knows his balance. In one embodiment, if the transaction is canceled or disapproved before sending to the blockchain, this invention will discount the number by one and this invention will resync over the owner application to make sure the number is synced. This is one of the main reasons why it is better for the payee to connect with our master wallet and do KYC, so it is never out of sync. This is also one of the value propositions for the GSM version, the CashCryps can resync itself. In one embodiment, the merchant receives from the server or the network the transaction approval. If the approval comes from the server, the approval can be converted in a different currency. If the merchant has requested a fiat currency, the merchant must have connected a PayPal (email), credit card (photo taken by application), or bank account (type in), when setting up the application.

In one embodiment, the PT receives an approval of the transaction over the internet and an email is sent to the merchant. The merchant may configure this invention to send the email per transaction, daily, or monthly. In one embodiment, this invention is comprised of a pay like credit card feature by storing the credentials of a credit card and submitting the stored credit card information to any pay terminal accepting contact less credit cards. The advantage is mass adoption and acceptance, as well as fraud protection via the credit card company. In one embodiment, this invention is comprised of storage of a regular credit card. In one embodiment, this invention is comprised of a pre-paid credit card filled from the crypto deposit or a regular card booking from the CashCryps service to recharge from the wallet.

In one embodiment, the CashCryps is an NFC enabled device and has secure flash memory embedded. In one embodiment, to copy a credit card on the invention the payee scans the credit card with its smartphone, enters the credentials, or uses a reader. In one embodiment, the smartphone sends the credit card credentials to the server of this invention, and the credentials cannot be read out, just deleted or replaced.

In one embodiment, with the 5 keys, the payee selects the credit card with which the payee wants to pay. In one embodiment, the payee enters “Y” and holds the invention to the PT for contact less credit card payment. In one embodiment, this invention is comprised of a pay device to device if no phone or pay terminal is in reach and one of the two devices has a GSM chip. In one embodiment, this invention is comprised of pay with CashCryps. In a preferred embodiment, this invention does not have the two-way authentication as it binds a private key to a real person.

When this invention contains the right amount of cryptocurrency, the payee can configure, deposit, or withdraw cryptocurrency to and from this invention, which is the same application the merchant uses. Once this invention holds the right amount of cryptocurrency, and is not protected, or just protected with a local pin code, the payee may give this invention to the merchant. In more than one embodiment, this invention is comprised of application device types. In one embodiment, the standard device type is comprised of an embedded microprocessor, NFC, BT, QI, LiPo battery, and buttons.

In one embodiment, the GSM/GPRS device type is comprised of an embedded microprocessor, NFC, BT, QI, LiPo battery, buttons, and GSM modem. In one embodiment, this invention has custom components that unpack the embedded CPU module from the metal cap and its own PCB and creates a specific eInk, and is comprised of custom packing for the LiPo battery. In one embodiment, the passive device type is comprised of an embedded microprocessor, NFC, and buttons. The passive device works only with the energy harvested from the NFC master, like a phone, pay terminal, or other device with a battery. In one embodiment, this invention is comprised of a wallet in Ethereum and ERC20. It is a pretty link number, the ID, that makes it unique and findable in the blockchain. This number is public and can only be used to send coins. In one embodiment, the number looks like 0x9d28Bfcb7dB29a722F286dd8A66D068279d7664B.

In one embodiment, the owner must also have a private key, otherwise the owner cannot access the wallet or send coins. In one embodiment, the ERC20 and Ethereum payment works by sending money a package is created. This package includes the sender ID, the receiver ID, the amount, a monotone increasing number and a fee. There is always a fee out of gas and nonce, effectively a small amount of Ethereum, so the payment is faster and the package is encrypted with the private key. In one embodiment, the private key is on an external hardware device that is offline and only used to create the package. In one embodiment, the package is sent to the Ethereum network and is processed and approved and written to the blockchain.

In one embodiment, without at least a small amount of Ethereum in the same wallet no transfer is possible in the Ethereum/ERC20 network. In one embodiment, the transaction takes a minimum of twenty minutes and a maximum of two hours. In one embodiment, the Ethereum protocol updates every 20 seconds and the transfer can take longer due to gas, priority, and load. For paying with CRYPS this invention verifies there is Ethereum on the same wallet.

1. An intravascular stent cape adapted for overlappable coverage, comprising:
(a) an impermeable seal dimensioned to cover a portion of a stent body;
(b) said cape having a first end and a second end;
(c) said first end comprising at least one telescoping attachment element adapted to join said cape to said stent body;
(d) said second end adapted to move freely about said stent body upon unsheathing;
(e) wherein said cape expands independently of said stent body upon deployment of said stent body.

2. The cape according to claim 1, wherein said cape is attached to an exterior surface of said stent body.

3. The cape according to claim 1, wherein said cape is attached to an interior surface of said stent body.

4. The cape according to claim 1, wherein said telescoping attachment element is joined to said stent body circumferentially.

5. The cape according to claim 1, wherein said telescoping attachment element is joined to said stent body longitudinally.

6. The cape according to claim 1, wherein said telescoping attachment element is attached to said stent body distally to a deployment device.

7. The cape according to claim 1, wherein said telescoping attachment element is attached to said stent body proximally to a deployment device.

8. The cape according to claim 1, wherein said cape is deployed under flow arrest.

9. The cape according to claim 1, wherein said cape is deployed via pharmacologic means.

10. The cape according to claim 1, wherein said cape is delivered through a balloon guide catheter with temporary balloon inflation to minimize blood flow bunching said cape during unsheathing.

11. The cape according to claim 1, wherein said stent body is detachable.

12. The cape according to claim 1 wherein said stent body is coiled.

13. An intravascular stent with at least two sealing fabrics adapted for overlappable coverage, comprising:
(a) said at least two sealing fabrics dimensioned to cover a portion of said intravascular stent;
(b) said at least two sealing fabrics, each said sealing fabric comprising a first end and a second end;
(c) said first end of each said sealing fabric disposed upon said intravascular stent, comprising a linear attachment element continuously affixed to said intravascular stent;
(d) said second end of each said sealing fabric adapted to move freely about said intravascular stent upon unsheathing;
(e) wherein said at least two sealing fabrics expand independently of said intravascular stent upon deployment of said intravascular stent, and
(f) wherein said first end of each said sealing fabric is attached to said intravascular stent, and other said sealing fabrics are attached to said intravascular stent adjacent to said other sealing fabric.

14. The at least two stent capes according to claim 13, wherein said at least two stent capes are dimensioned such that said second end overlaps said telescoping attachment element said stent cape immediately adjoining said other stent cape.

15. The at least two sealing fabrics according to claim 13, wherein said at least two sealing fabrics cover said intravascular stent circumferentially.

16. The at least two sealing fabrics according to claim 13, wherein said at least two sealing fabrics partially circumferentially cover said intravascular stent such that blood may flow to a branch in a target vessel.

17. The at least two sealing fabrics according to claim 13, wherein said at least two sealing fabrics are attached to an exterior surface of said intravascular stent.

18. The at least two stent capes according to claim 13, wherein said at least two stent capes are attached to an interior surface of said stent body.

19. The at least two sealing fabrics according to claim 13, wherein said at least one said sealing fabrics are attached to said intravascular stent externally.

20. The at least two stent capes according to claim 13, wherein said at least one said stent cape is attached to said stent body internally.
